(19) United States
(12) Patent Application Publication
(10) Pub. No.: US 2002/0190109 A1
(43) Pub. Date: Dec. 19, 2002

(54) Packing drum with a melt adhesive and charging with adhesive

(76) Inventors: Paul Mrgan, Essen (DE); Gerald Petry, Hueckelhoven (DE); Franz-Georg Henrichs, Hilden (DE)

Correspondence Address: HENKEL CORPORATION, 2500 RENAISSANCE BLVD, STE 200, GULPH MILLS, PA, 19406, US

(21) Appl. No.: 10/149,521

(22) PCT Filed: Dec. 6, 2000
(86) PCT No.: PCT/EP00/12264

(30) Foreign Application Priority Data
Dec. 10, 1999 (DE) 199 59 840.1

(51) Int. Cl. B65B 31/00; B65D 3/10; B67B 3/28

(52) U.S. Cl. 229/5.5; 53/433; 53/440; 53/471; 229/4.5

(57) ABSTRACT

The invention relates to a packing drum containing a moisture cross-linking melt adhesive (8) which is surrounded by a moisture-tight can comprising a lid (2) made of a composite material, PE- or PP-coated white sheet metal consisting of a casing (1) and a floor. The floor has the form of a moisture-tight flexible membrane (3). The packing drum can in particular be charged in a very economic manner with adhesive.

This invention relates to a container for a moisture-crosslinking hotmelt adhesive surrounded by a moisture-proof can which comprises a cover, a casing of composite material and a base.

More particularly, the invention relates to a container for a reactive hotmelt adhesive, more particularly a moisture-crosslinking polyurethane hotmelt adhesive. Adhesives such as these are suitable for particularly high-quality bonding. They are distinguished by very good adhesion properties and excellent strengths. They are applied at about 120° C. and, after cooling, react with atmospheric moisture or with the paper to form high molecular weight, barely meltable bonds. The high ultimate strength is achieved by the chemical reaction of free isocyanate groups with surface moisture and with H-active chemical groups of the substrate surfaces. In addition, they are distinguished by high resistance to chemicals, for example to printing ink oil, and by high heat and aging resistance. They require particular melting and application equipment and involve high processing costs.

These solid, rapidly crosslinking polyurethane-based hotmelt adhesives are used in the automotive industry, in the wood and furniture industry, in the graphic industry and bookbinding, in the textile industry, in the shoe industry, in PE bag manufacture, in general industry and in the electrical and electronics industries. The products marketed by applicants under the names of Purmelt, Macroplast QR and Terorehm MC are mentioned as examples of these adhesives.

At the end user, the moisture-crosslinking adhesives are melted and sprayed—generally through very fine nozzles—onto the substrate to be bonded. Blockage of the nozzles by adhesive particles already cured by moisture has to be strictly avoided because it would lead to stoppage of the installation. Consequently, these adhesives have to be presented by the manufacturer in substantially moisture-proof packs which provide for high storage stability in the absence of moisture, for example atmospheric moisture.

Accordingly, it is known that the adhesive can be introduced in its hot liquid state into a film bag which, after cooling of the hotmelt adhesive, is hermetically sealed by vacuum welding. The bag consists of a polyethylene-laminated aluminium foil, the aluminium providing protection against atmospheric moisture.

The user cuts the film open with a knife and peels the film from the solid product. Undercuts and, above all, creases in the film are a considerable disadvantage because, in this case, the film is very difficult or impossible to remove from the solid hotmelt adhesive block. In addition, the film bag cannot be completely emptied.

A container of the type mentioned at the beginning is known from European patent application EP 0 844 186 A1. The can has a casing and a base which both consist of a composite material and have an internal volume of 0.5 to 5 liters and preferably 1 to 3 liters. A moisture-proof layer, for example of aluminium or plastic, is provided on the outside. The inner layer consists of a material which does not adhere to the hotmelt adhesive, for example of silicone-based polymers, PTFE or the like. The middle layer provides for the stability of the container and consists of paper, cardboard or plastic. A rigid cover closes the can thus formed.

Unfortunately, this container is only suitable for hotmelt adhesives which do not undergo any significant thermal contraction in volume on cooling from the liquid state because otherwise the can would be deformed. This limitation is also mentioned in the patent application (cf. column 2, lines 36 to 40).

If moisture-crosslinking adhesives with a distinct contraction in volume on cooling from the liquid state are to be packaged, the virtually inflexible pack known from EP 0 844 186 A1 is not suitable unless it is left largely empty, for example is only half-filled. However, this would not be economical.

In the prior art, the film bags already mentioned above are used for this purpose. After they have been filled with the hot hotmelt adhesive, the film bags are first provisionally closed to protect them against moisture. When the adhesive block has reached its final volume after cooling, the film bag is opened on top and then welded in vacuo. The advantage of this is that the user is able to detect any leaks immediately because faulty film bags no longer fit closely around the adhesive block.

The disadvantages of the prior art include the relatively complicated filling of the film bags and, above all, the relatively long period of time elapsing from filling of the film bag with the hotmelt adhesive to the final sealing of the film bag. This period is largely determined by the cooling time.

Accordingly, the problem addressed by the present invention was to provide a container of the type mentioned at the beginning which would enable the pack to be definitively closed immediately after filling with the hot and liquid hotmelt adhesive so that the overall filling time would be considerably shortened. In particular, the container would even be suitable for hotmelt adhesives with a considerable thermal contraction in volume during cooling. In addition, the user would be able to tell whether the container was still hermetically sealed and moisture-proof, as in the case of the above-mentioned film bags.

In a container of the type mentioned at the beginning, the solution to this problem as provided by the invention is characterized in that the base is in the form of a moisture-proof flexible membrane and a flange is preferably integrated in the cover.

For filling, the cover is removed from the can and the hot and liquid hotmelt adhesive is introduced into the can. The flexible membrane first arches downwards during the filling process. After the can has been closed by the cover so that it is moisture-proof and airtight, the filling process is terminated. During cooling, the hotmelt adhesive undergoes a contraction in volume. By virtue of the impermeable construction of the can and the minimal volume of gas in the pack, the membrane forming the base of the can and optionally the flange in the cover arch inwards so that the contraction in volume is compensated in addition to the volume compensation by the membrane. The user is able to tell by looking at the cover whether the pack is still moisture-proof and airtight. If the flange is still in its inwardly directed position, the pack is fault-free. However, if the can is damaged, the flange is able to arch outwards again, thus indicating the fault.

The behavior of the flexible membrane would not be surprising if the hot hotmelt adhesive remained a liquid, even after cooling, and the membrane thus retained its flexibility. However, it is extremely surprising that, even for solids, the flexible membrane at the bottom of the pack is a suitable means of compensating the contraction in volume during cooling of the melt from—generally—well above 100° C. to room temperature (20° C.). This is because it had been expected that the melt would solidify on contact with the flexible membrane at the bottom of the pack and would become hard there first and to the greatest extent. The solidified “bottom layer” of the cooled adhesive would thus itself be an obstacle to deformation of the flexible membrane into the interior of the pack when the melt cools inside the pack and contracts in volume.

In one advantageous embodiment, the membrane allows a change in the internal volume of the can of 1:50 to 1:500 and more particularly 1:100 to 1:300, based on the internal volume of the can.

In another advantageous embodiment, the membrane consists of aluminium and has a thickness of 30 to 100 μm. However, a membrane (=flexible layer) of one or more other materials may also be used.

Composites with a Layer of Aluminium are Particularly Suitable.

A can with an internal volume of 1,000 ml to 20,000 ml is preferred.

In order to prevent atmospheric moisture from entering the pack from outside and at the same time to obtain a stable container at relatively low cost, the casing preferably consists outside of paperboard or cardboard with at least one moisture-proof inner layer. In a favorable embodiment, the hotmelt adhesive is prevented from sticking to the inner layer by providing the moisture-proof inner layer with an outer metal layer, more particularly an aluminium foil, which thus forms the middle layer of the casing, and an inner plastic layer, more particularly of polyethylene or polypropylene. The choice of this plastic layer is determined by the need to prevent sticking of the hotmelt adhesive.

The casing is preferably a tube wound from a coated paperboard or cardboard web and then welded or bonded. Wound paperboard containers are known per se and are easy to tear open along the bond or weld seam.

At high filling temperatures of, for example, 100 to 200° C., suitable adhesives, particularly plasticizer-free high-polymer dispersion-based adhesives and 1- or 2-component polyurethane adhesives, are appropriate for bonding the individual layers of the moisture-proof can, more particularly the wound paperboard can. For example, wound paperboard cans can readily be filled with melts with a temperature of 170° C. providing they have been bonded with Adhesin A 7093, an adhesive from Henkel KGaA.

In another embodiment of the invention, the impermeability of the casing to moisture penetrating from outside is reliably guaranteed if the moisture-proof lining on the inside of the casing is drawn around the edges of the paperboard or cardboard web and the linings of the adjoining edges lie directly one on the other in moisture-proof manner at the welded or bonded edges. A casing with this construction is known from the prior art for the moisture-proof packaging of foods, for example for soluble coffee powder. However, such a construction has not hitherto been used for the packaging of moisture-crosslinking hotmelt adhesive.

In another embodiment, the cover consists of sheet metal, more particularly tin plate. The cover is thus generally so stable that it does not deform during cooling of the hotmelt adhesive. Only the membrane forming the base deforms by arching inwards. All parts in contact with the product are coated with PE or PP.

To protect the membrane, particularly in transit, an additional cover with a vent opening is arranged, in particular removably, at the bottom of the can. The vent opening is necessary for compensating pressure during the movement of the membrane.

The present invention also relates to a process for filling a container of the above-mentioned type according to the invention with a hotmelt adhesive.

In this process, the can—which is preferably cooled at least at its base—is filled with the hot melt which has a temperature of generally above 50° C. and more particularly above 100° C. When the can is largely full, more particularly brimful, it is closed in airtight, moisture-proof manner by the cover. The not quite full can with a gas volume of at most 10% by volume and more particularly at most 5% by volume, based on the volume of melt in the can, is optionally purged beforehand with a dry inert gas, more particularly nitrogen. The closed can holding the hotmelt adhesive is then cooled to room temperature.

As mentioned above, particularly economic filling is achieved if the can is filled with the hot liquid hotmelt adhesive, the can is closed in airtight, moisture-proof manner with the cover, optionally after purging with a dry inert gas, more particularly nitrogen, and the hotmelt adhesive is allowed to cool.

The inert gas must not react with the reactive groups of the reactive hotmelt adhesive. These reactive groups are, above all, epoxy, siloxane and in particular isocyanate groups. They are chemically fixed to a thermoplastic polymer, more particularly to a polyurethane, and effect its crosslinking with reactive substances, more particularly with water in liquid or gaseous form. Reactive epoxy and polyurethane hotmelt adhesives are specifically mentioned.

The hotmelt adhesives may also be suitable for sealing, coating and filling and for the production of molds.

One example of embodiment of the invention is described in detail in the following with reference to the accompanying drawings, wherein:

FIG. 1 is a perspective view of the can according to the invention from below with the lower cover removed.

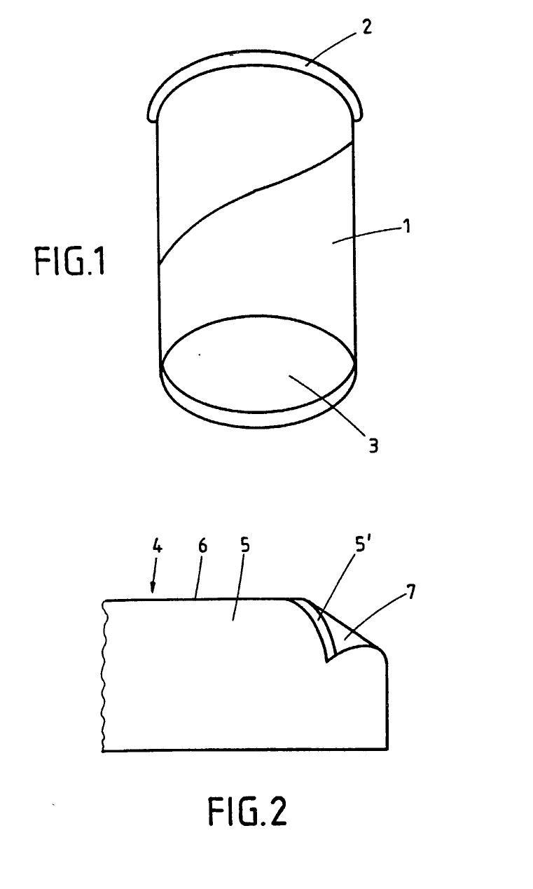

FIG. 2 shows a coated paperboard web for making the casing of the can.

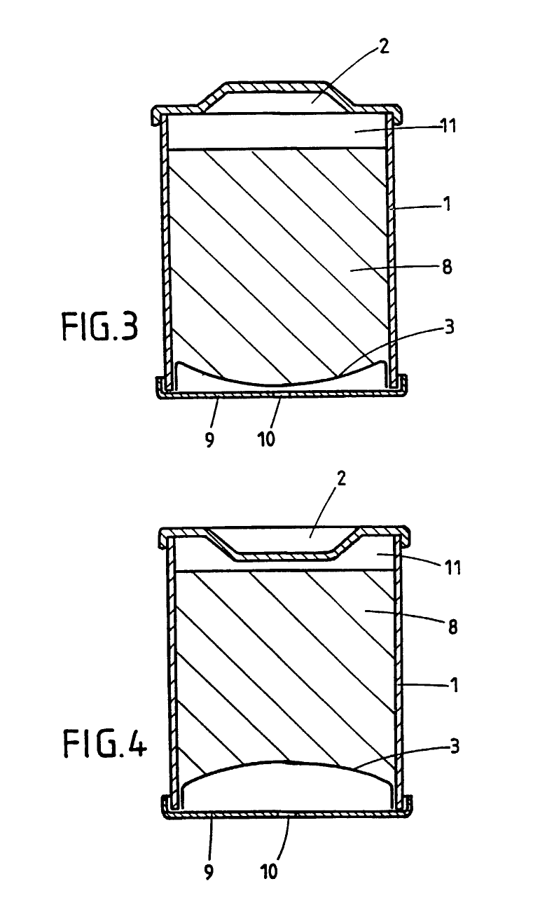

FIG. 3 is a longitudinal section through the container according to the invention filled with the hotmelt adhesive before cooling of the adhesive.

FIG. 4 is a longitudinal section corresponding to FIG. 3, but after cooling of the adhesive.

In all the drawings, the same reference numerals have the same meanings and, accordingly, may only be explained once.

The can shown in FIG. 1 advantageously designed for automatic filling consists essentially of a wound, internally coated paperboard casing 1, an upper, tightly closing and stable flanged cover 2 of tin plate and a membrane 3 of aluminium foil bonded or welded in place at the bottom of the can. All parts in contact with the product are coated with PE or PP.

The coating of the paperboard web 4 is shown in FIG. 2. The moisture-proof lining 5 consisting of an inner aluminium foil and an outer plastic film is drawn around the edge 6 of the paperboard web 4, the lining 5 lying on the inside in the finished can and the edge 5′ lying directly on the corresponding lining of the wound layer so that a moisture-proof casing 1 is obtained. The side 7 of the paperboard web 4 which is only partly visible in FIG. 2 lies on the outside in the finished can and consists of paperboard.

After it has been filled with the moisture-crosslinking hotmelt adhesive 8, the can is closed with the cover 2 so that it is airtight and moisture-proof without waiting for the hot hotmelt adhesive 8 to cool. The weight of the hotmelt adhesive 8 presses the membrane 3 outwards, as shown in FIG. 3.

On cooling, the adhesive 8 contracts in volume. Since the can is hermetically sealed, only the membrane 3 and the flange in the cover can arch inwards, as shown in FIG. 4. To this end, the stable additional cover 9 fitted to the underneath of the can to protect the membrane 3 has a vent opening 10.

As shown in FIGS. 3 and 4, the membrane 3 is fixed at its edge to the inner lower edge of the casing 1, more particularly by welding or bonding. The membrane 3 may advantageously be a plastic-coated aluminium foil, the plastic layer lying on the inside and facilitating removal of the hotmelt adhesive 8 by the user.

One advantage of the container according to the invention is that it can be filled particularly quickly and—in contrast to the prior art automatically. If the flange in the cover 2 (FIG. 4) is directed inwards, the user can tell that the can is undamaged and that no moisture has penetrated into the hotmelt adhesive. There are none of the undercuts or creases of the known film bag in this container. If desired, the space 11 above the hotmelt adhesive 8, which has a height of about 2 cm in a typical 2 kg can, may be filled with an inert gas, for example nitrogen. Removal of the pack is particularly easy by virtue of the way in which the casing is wound. To this end, the cover 2 is first cut from the casing 1 and the casing 1 is then peeled off the adhesive block together with the membrane 3.

The adhesive block is preferably cylindrical so that it is able to roll down a sloping surface.

The 2 kg container according to the invention is particularly suitable for the wood, shoe and automotive industries and for bookmaking where the reactive hotmelt adhesive is typically used continuously in large quantities for safely bonding paper, paperboard, wood, metals, glass and plastics, particularly elastomers, firmly to one another without any problems.

The membrane 3 may even be directly joined to the additional cover 9. However, the embodiment illustrated in the drawings is preferred.

List of Reference Numerals

1 casing

2 cover with flange

3 membrane

4 paperboard web

5,5′ lining

6 edge

7 side

8 hotmelt adhesive

9 additional cover

10 vent opening

11 space

1. A container for a moisture-crosslinking hotmelt adhesive (8) surrounded by a moisture-proof can which comprises a cover (2), a casing (1) of composite material and a base, characterized in that the base is formed by a moisture-proof flexible membrane (3).

2. A container as claimed in claim 1, characterized in that the membrane (3) allows a change in the internal volume of the can of 1:50 to 1:500 and more particularly 1:100 to 1:300, based on the internal volume of the can.

3. A container as claimed in any of the preceding claims, characterized in that the membrane (3) consists of aluminium.

4. A container as claimed in the preceding claim, characterized in that the membrane (3) has a thickness of 30 to 100 μm.

5. A container as claimed in any of the preceding claims, characterized in that the can has an internal volume of 1,000 to 3,000 ml.

6. A container as claimed in any of the preceding claims, characterized in that the casing (1) consists externally of paperboard or cardboard with at least one moisture-proof inner layer (5).

7. A container as claimed in the preceding claim, characterized in that the moisture-proof inner layer (5) has an outer metal layer, more particularly an aluminium foil, and an inner plastic layer, more particularly of polyethylene or polypropylene.

8. A container as claimed in claim 6 or 7, characterized in that the casing (1) is in the form of a tube wound from a coated paperboard or cardboard web and then welded or bonded.

9. A container as claimed in the preceding claim, characterized in that the moisture-proof lining (5) on the inside of the casing (1) is drawn around the edges (6) of the paperboard or cardboard web (4) and the linings (5,5′) of the adjoining edges lie directly one on the other in moisture-proof manner at the welded or bonded edges.

10. A container as claimed in any of the preceding claims, characterized in that the cover (2) consists of sheet metal, more particularly tin plate.

11. A container as claimed in any of the preceding claims, characterized in that an additional cover (9) with a vent opening (10) is arranged, in particular removably, on the base of the can.

12. A process for filling the container claimed in any of the preceding claims with hotmelt adhesive, characterized in that the can is filled with the hot liquid hotmelt adhesive (8), the can is closed in airtight, moisture-proof manner with the cover (2), optionally after purging with a dry inert gas, more particularly nitrogen, and the hotmelt adhesive (8) is allowed to cool.
